(19) United States
(12) Patent Application Publication
(10) Pub. No.: US 2009/0055329 A1
(43) Pub. Date: Feb. 26, 2009

(54) On-line, Real-Time, Property and Casualty Loss Estimation System and Method

(75) Inventors: Patrick M. Catania, Miami, FL (US); Carlos V. Freyre, Miami, FL (US)

Correspondence Address: THOMPSON COBURN, LLP, ONE US BANK PLAZA, SUITE 3500, ST LOUIS, MO, 63101, US

(73) Assignee: SmartClaims.com, LLC, Coral Gables, FL (US)

(21) Appl. No.: 11/844,917

(22) Filed: Aug. 24, 2007

(51) Int. Cl. G06Q 99/00

(52) U.S. Cl. 705/400

(57) ABSTRACT

An interactive, real-time, property and casualty loss estimation system and method includes a web portal comprising a computer configured to allow a qualified user to sign in over the internet and create an estimate reflective of the true cost to renew a property from a casualty loss. The user enters data from an insurance company loss estimate which in many instances is devoid of consideration of issues such as matching finishes, bringing a property up to standard for changes in building and municipal code, and ancillary costs such as permitting fees. In operation, a final affidavit with a supporting loss estimate is made available for printing by the user to submit to an insurance company to negotiate an increased settlement more fully covering the costs needed to property to a pre-loss condition.

### BACKGROUND AND SUMMARY OF THE INVENTION

It is an unfortunate incidence of home ownership that some type of casualty or property loss is likely to eventually occur, necessitating that the home owner become involved with his insurance company to make a claim and see to having his property repaired/renewed. While some small number of home owners are savvy, or become savvy through repeated unhappy experience, most are ignorant of the process including knowing the full extent of their rights under their insurance policy.

The statistics concerning these claims are surprisingly enormous. For example, there are typically 7 million claims made annually against homeowners policies by individual homeowners for casualty losses not involved in major catastrophes. In satisfaction of these claims, approximately $43 billion is annually paid. That averages to a little more than $6,000 per claim, not including amounts not reimbursed due to deductibles, denied coverage, etc. For these smaller types of claims, a homeowner will typically rely on his insurance agent, friends, or others generally not familiar with the claims process for help in filling out the necessary forms, etc. in order to obtain reimbursement for his loss. In some states, public adjusters are available for hire by a home owner and many of these adjusters are very helpful in obtaining the full benefits allotted under the insurance policy. However, the cost for these adjusters generally prices them out of consideration for hire by a homeowner for a smaller claim, such as the typical claim identified above. Additionally, due to a homeowners naiveté, even for those claims which would justify use of a public adjuster a homeowner forgoes such assistance. For these and other reasons, a typical homeowner may well experience frustration in negotiating through the claims process and end up with a final adjustment or claim satisfaction which is not satisfactory in that his property would not be returned to an “as new” condition, and possibly even short of what he would legally be entitled to under the terms of his policy. It must be remembered that a homeowner is left to negotiate with a claims adjuster who has as his job, the task of negotiating with homeowner after homeowner, on a daily basis, their claims. In essence, the amateur homeowner is dealing with the professional claims adjuster. And, although the homeowner is the insurance company's customer, the insurance company is motivated to do the minimum, and spend the minimum, to satisfy each claim. After all, the insurance company is in business to make money for their shareholders so their motivation is to not help but instead oppose a claimant's request for assistance as to the true range of benefit for claims.

To address these unsolved needs and to remedy those and other shortcomings in the prior art, the inventors herein have designed and developed an on-line, real-time, property and casualty loss estimation system and method for using same to assist an uninitiated homeowner or other property owner in estimating his true loss due to any casualty, while at the same time producing a proof of loss estimate/affidavit for submittal to the insurance company as supporting evidence for his claim. The preferred embodiment of the invention is embodied in a web server, or internet portal, comprising of a computer program that displays a series of interactive web pages presented in a logical set of ordered inquiries, which allows the homeowner, upon accessing the web site and qualifying himself to use the service, to enter the data requested as needed to describe his loss in terms convertible by the computer ultimately into a damage estimate. The initial qualifying portion of the program is preferably gathering identifying data from the user, validating his permission to use the program such as by requiring payment through a credit card or entering data establishing his right to use under a pre-qualified arrangement, and then allowing further access to the program. Once validated, the user is then presented with a series of web pages presenting questions requiring answers before successive web pages are displayed.

There are a number of particularly unique features embodied in the preferred embodiment. For example, one such feature is that the program identifies “matching” issues which go beyond what a typical homeowner would be familiar with. To be more specific, a loss may occur in which a carpet is damaged and needs replacing. In that instance, the homeowner may be offered a replacement for only that portion of his carpet that has been damaged, matched as best as can be matched with the undamaged portion. However, in most instances, worn or faded carpet, even after only a year or two of usage, is virtually impossible to be matched and while the “matched” carpet may not be unsightly, the finished result is not equivalent to the finished and fully matching carpet prior to the loss. Many insurance policies in these “matching” situations provide that the policyholder's property is to be renewed or restored to its original condition and that has generally been interpreted to include in this example replacement of all of the carpet with new carpet. The preferred embodiment includes logic that guides the user into providing information concerning matching situations, gathers data relating to those matching elements, and produces loss estimates detailing these matching elements for inclusion in the loss estimate. Matching issues can come up with respect to surface finishes such as carpeting, painting, wallpaper; construction materials such as roof tiles, brick or brick veneer, siding such as aluminum siding, flooring materials such as hardwood flooring; and other elements subject to loss or damage such as might be covered by a homeowner's or other casualty loss policy such as appliances, etc.

Another unique feature includes providing an estimate not only based on the current cost of construction, but also the cost as necessary to upgrade the damaged or related element to present building code, based on the location where the property is. While some repairs would necessarily require compliance with the new code, others would desirably be upgraded to new code and in those instances it is doubtful that an insurance company would voluntarily offer to foot the expenses to upgrade to code. This increased expense would be automatically included in a loss estimate and presented to the insurance company in a claim, and ordinarily approved for payment.

Yet another particularly unique feature includes providing cost estimates which include ancillary costs and other incidentals which, surprisingly, are many times forgotten but which eventually have to be paid by the homeowner in order to get the work completed. Examples include sales tax, permitting costs incurred when obtaining work permits from a local or municipal authority, etc. These costs are necessary to the homeowner being made whole and are properly reimbursable by the insurance company and in most instances are fully included in the coverage. These costs are automatically added to the loss estimate.

The preferred embodiment of the present invention is preferably implemented on a computer, connected to the internet through a web portal for wide access, and user friendly through the use of a question and answer format which guides a user through the process of inputting all the necessary information required to calculate a loss estimate and produce a proof of loss for submittal to the insurance company. The loss estimate includes a series of attachments, forming a schedule which itemizes the necessary tasks to achieve a “renewal” of the property. This schedule is detailed and in a form that is virtually self explanatory to the insurance company to provide a comprehensive backup for the claim. The preferred embodiment utilizes a program written in HTML which accesses a modular database, with the database being readily customized to provide accurate costing information to the construction industry by zip code. That includes labor costs, materials, local practices, etc. Furthermore, the database may be readily updated in recognition of rising prices in times of duress or shortage, as prices can swiftly change should large scale devastation occur in a local area. Other less time sensitive changes are also readily implemented, such as labor union contract negotiations raising labor rates, etc.

Yet another aspect of the preferred embodiment is the modular construct of the cost information within the database. Various common tasks, such as replacing an interior door, involve a number of sub-tasks such as removing the old door, sizing the new door, replacing the door hardware, applying a matching finish to the new door, etc. Each of these sub-tasks themselves involve a corresponding set of sub-tasks, and in some instances different trades such as a carpenter and painter for applying a matching finish. The data base is designed and constructed to allow these sub-tasks to be accumulated and added together to arrive at the finished estimate. This degree of granularity allows for precision in not only maintaining the database, but also provides credence to the estimate that makes it difficult for an insurance company to rebut. This greatly increases the persuasiveness of the proof of loss and likelihood that an insurance settlement will more likely cover the true expenses to return the property to an “as new” or “renewed” condition.

In many instances, the user will be in possession of an insurance company estimate before he makes use of the invention. In those many instances, the user will have the additional advantage of using the estimate as a road map to further help guide him through the process. However, it is also true that in many instances the insurance company estimate will have missing tasks, missing collateral issues such as the matching issues and also code upgrade issues. Thus, the experience with the limited trial uses of the invention has demonstrated a dramatic difference between the calculate loss and the insurance estimate. One such example is that a roof damage was estimated at approximately $1700, the proof of loss estimate obtained through use of the invention was approximately $60,000, and the final settlement paid by the insurance company was approximately $48,000, demonstrating the power and effectiveness of the present invention.

While the principal advantages and features of the preferred embodiment have been described above, a more thorough understanding of the invention may be attained by referring to the drawings and detailed description which follow.

### BRIEF DESCRIPTION OF THE DRAWINGS

FIG. 1 is a diagram depicting the typical type of interaction expected with the invention, identified as to their role;

FIGS. 2a-2d are a set of diagrams depicting in a logical flow the data entry aspect of the invention;

FIG. 3 is a diagram depicting the relationship of the common requirements of a claim;

FIG. 4 is a diagram depicting the use case for maintaining a user's profile;

FIG. 5a-5b are a set of diagrams depicting the use case for simple content management;

FIG. 6 is a diagram depicting the use case for customer sign up;

FIG. 7a-7b are a set of diagrams depicting the use case for calculation of the loss, generating a loss estimate, and matching; and

FIG. 8a-8c are a set of diagrams depicting a use case for system administration.

### DETAILED DESCRIPTION OF THE PREFERRED EMBODIMENT

The logical flow of the programming is illustrated in the form of the preferred embodiment, and as exemplified in a series of functional diagrams forming the figures. When coupled with the database description attached hereto as Exhibit A, and considered along with the balance of the specification, one of ordinary skill could readily program a computer without undue experimentation to perform the functional operations described herein. As such, this disclosure is to be considered as illustrative of the preferred embodiment, and not limiting.

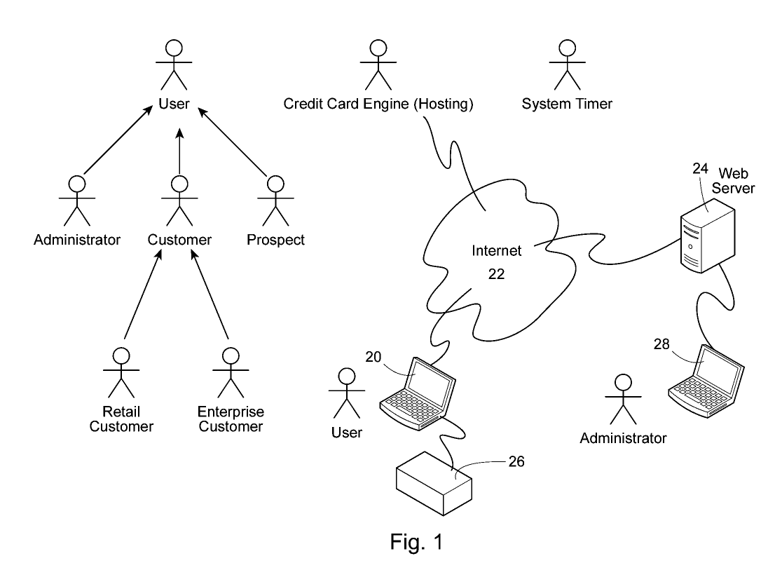

As shown in the diagram of FIG. 1, there are various individuals who are considered typical “users” for interacting with the system of the present invention. An administrator has access to the database and other background details in order to update and keep the system running, and otherwise perform system administrator functions. A customer could be an individual, or “retail” customer, or a corporate or other group account may allow its “enterprise” members to be users. And, a visitor may browse to the site and be a prospect for becoming a user in the future. Also depicted is a user having access through a computer 20 over the internet 22 to a web server 24 or the like in which the program functionality/database of the present invention would preferably be stored. In this manner, a user in virtually any location could access and use the invention. A local printer 26 connected to the computer 20 is desirably used to print out a proof of loss statement for submittal to the insurance company after the user inputs the data, the loss is calculated including calculation of any matching issues, code update issues, incidentals, and any other ancillary features. The web server 24 may have a local computer 28, or a remote computer such as might be connected over the internet, for use by an administrator to monitor, update, trouble shoot and otherwise maintain the operation of the program. Additionally, a credit card host may be accessed through the internet for credit card approvals of retail or individual customers, as known generally.

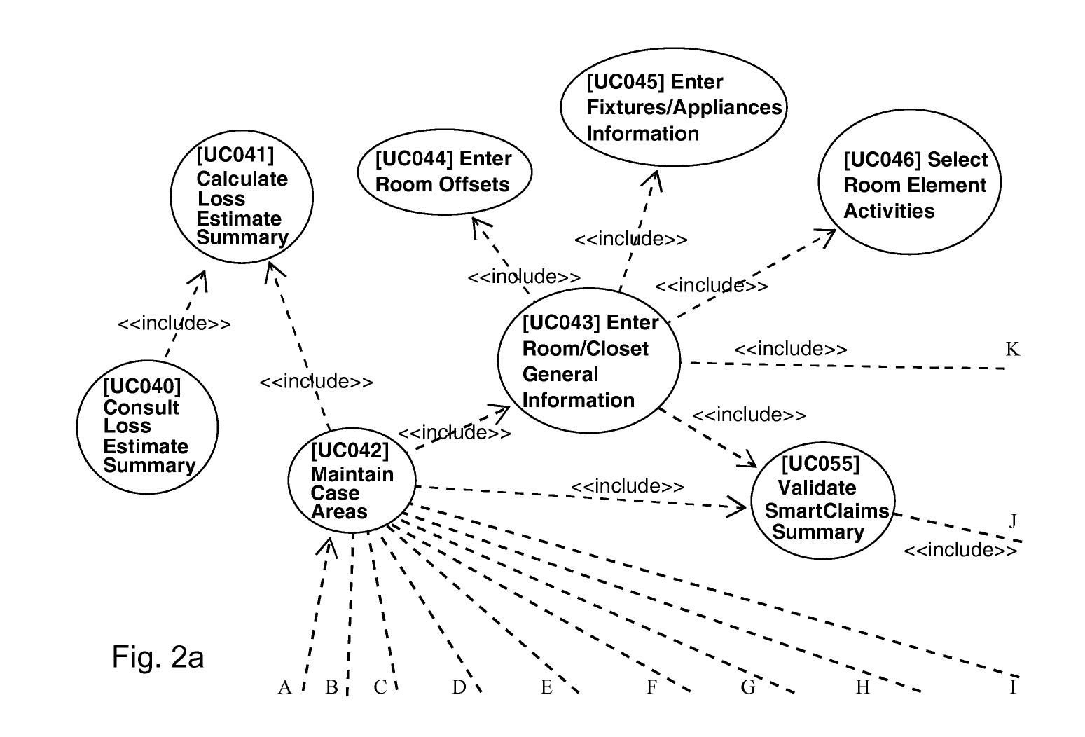

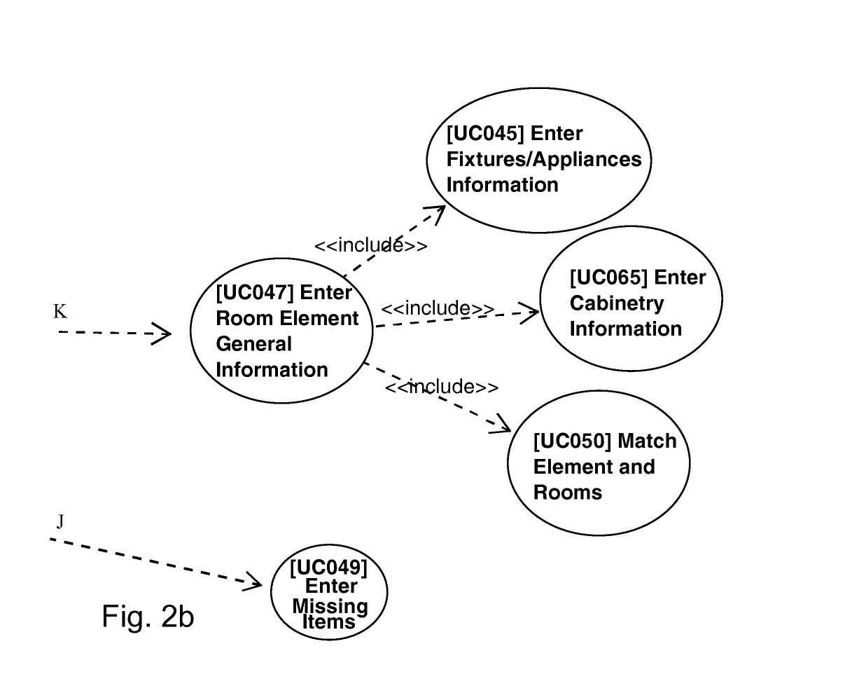

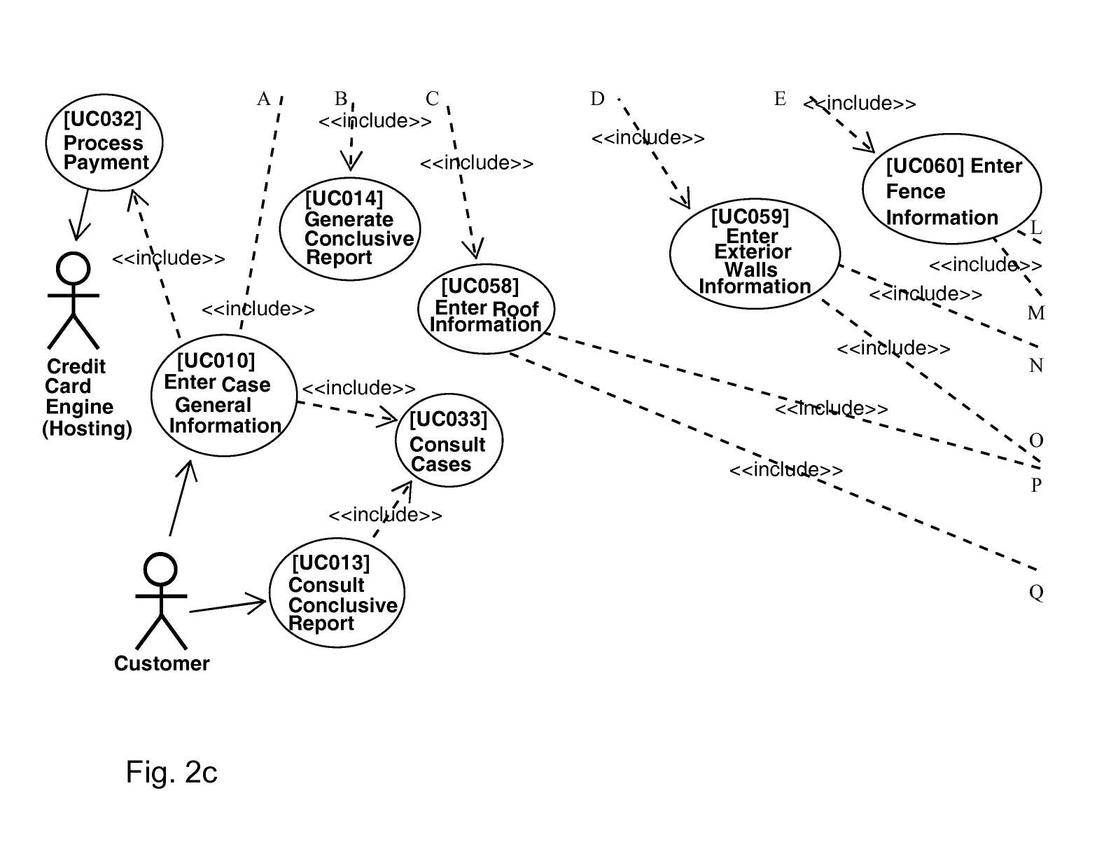

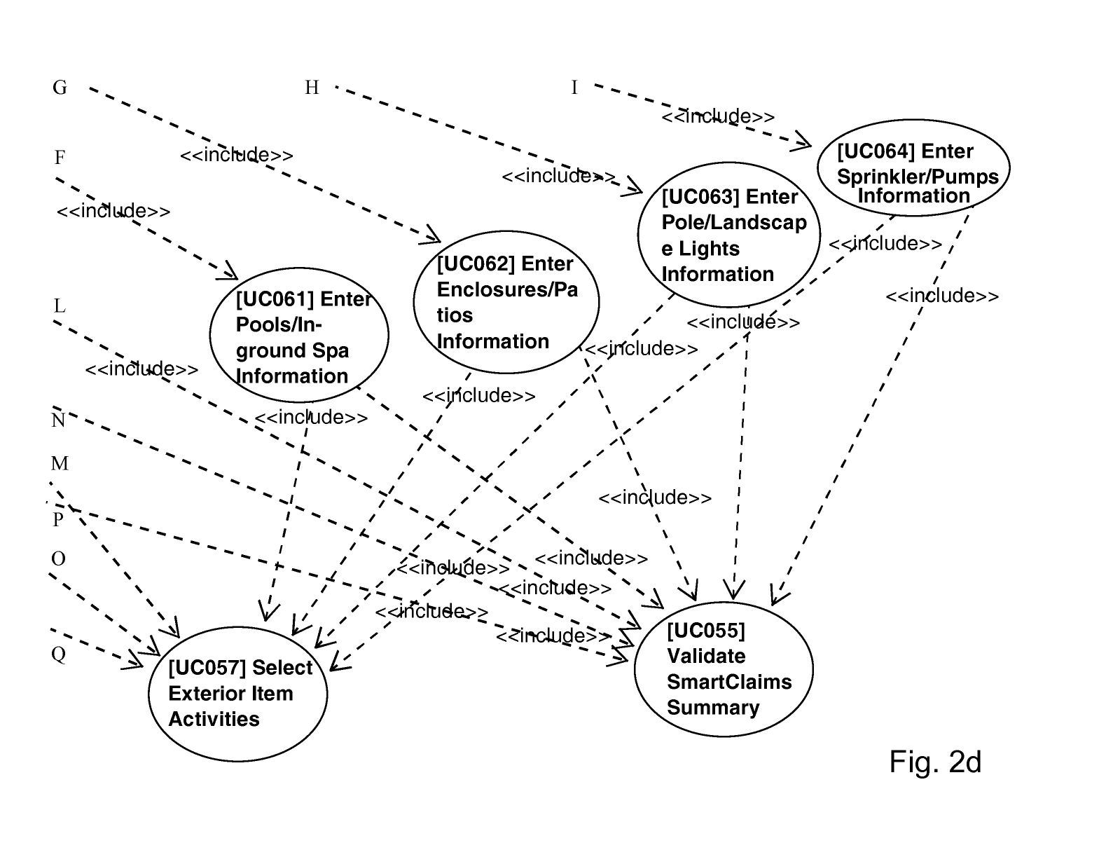

As shown in the diagram of FIG. 2c, upon accessing the web site, a customer enters use case 10 (identified in the drawing figures as UC010, and subsequent reference to these use cases will follow this convention for ease of reference), from which his credit card payment may be processed by use case 32 and after which he is routed to use case 42 which maintains the case areas. From there, the user/customer is routed to the various use cases requesting information concerning the damaged property. For example, in FIG. 2a, use case 43 requests room/closet general information, and further allows the user to input data pertaining to any room offsets (use case 44), fixtures/appliances (use case 45), and room element activities (use case 46). In FIG. 2b, after entering room element general information with use case 47, the user enters cabinetry information through use case 65 and any matching element or room information through use case 50. Use case 55 (FIG. 2d) validates the claims summary, and includes use case 49 (FIG. 2b) for entering missing items. These use cases help the user avoid missing any possible damaged elements or items, as explained below. This set of use cases are used to enter data relating to room damage and are included in almost every claim. Other building elements are also entered for inclusion in a claim through additional use cases.

As further shown in the diagram of FIG. 2d, a user may enter data relating to damage experienced to sprinklers/pumps (use case 64), poles/landscape and lights (use case 63), enclosures/patios (use case 62), pools and in-ground spas (use case 61). As further shown in the diagram of FIG. 2c, a user may enter data relating to damage experienced to fences (use case 60), exterior walls (use case 59), and roofs (use case 58). As shown in FIG. 2d, each of these use cases also guides a user to select exterior item activities required to be addressed in the claim, as shown in use case 57; and validates the claims summary through use case 55. Also depicted in FIG. 2c is the users ability to generate a conclusive report (use case 14), and consult either his case (use case 33) or the conclusive report (use case 13). Ordinarily, the system would not allow a user to modify a conclusive report once it has been generated and instead would require a user to begin a new case/claim. This helps keep the record keeping for the various claims a user may wish to make, and also ensures that a user does not bypass his obligation to pay for each claim for which he desires a conclusive report.

The functionality depicted in FIGS. 2a-2d is the principal “engine” for data entry by a user which allows him to define the parameters of his claim, as he knows it. This information is amplified to request from him data for matching elements, and then used to help calculate the claim.

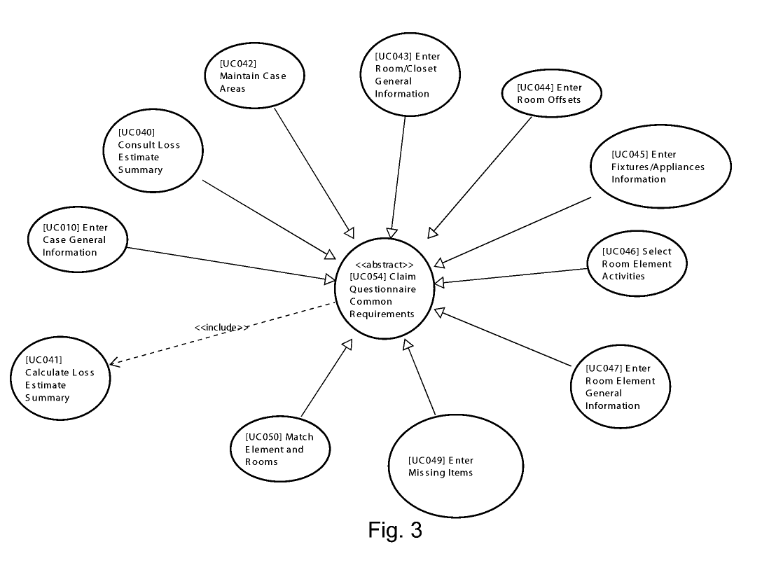

As shown in FIG. 3, calculation of the loss estimate summary in use case 41 involves assembling a number of claim questionnaire common requirements in use case 54 from the use cases as shown in FIG. 2. These are then used to calculate the loss estimate summary.

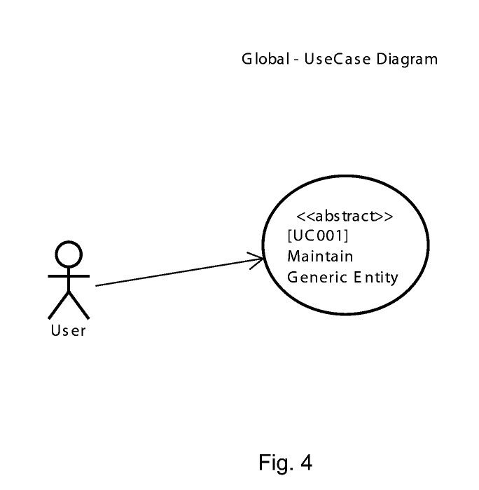

FIG. 4 depicts the user's ability to maintain an enterprise or generic entity, for multiple users identified as part of a group.

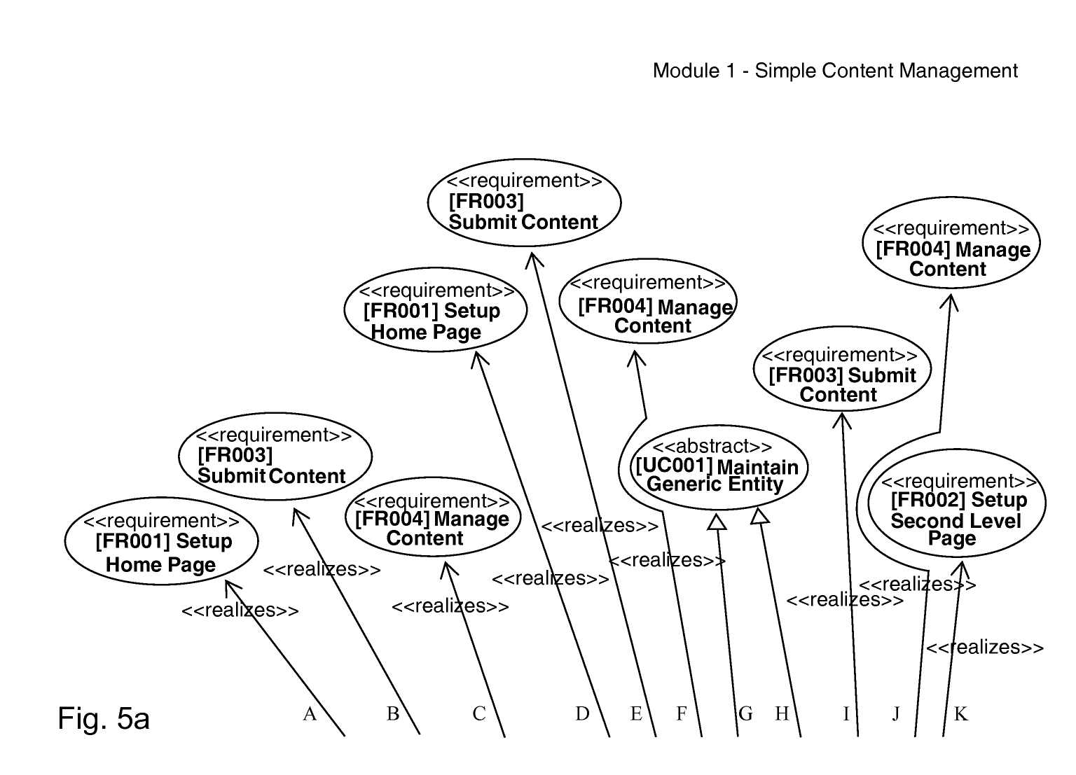

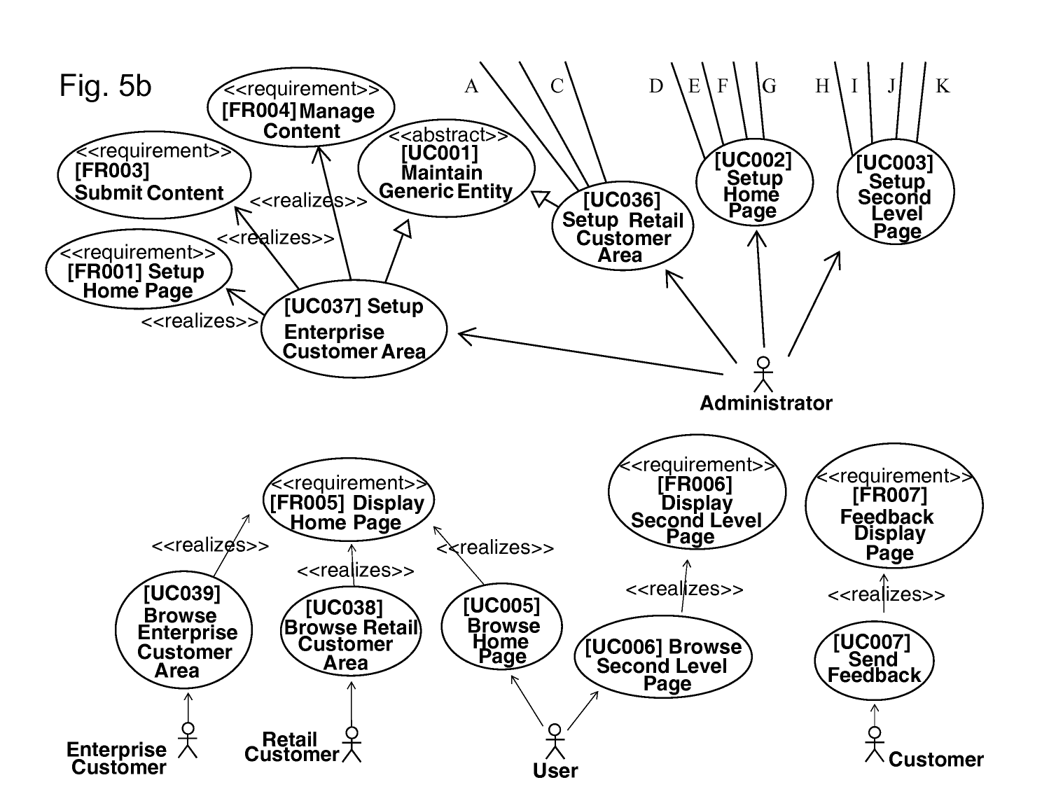

FIGS. 5a-5b depict the administrator's access and management of the content, both for individual users and enterprise users, and for home pages and other page content. Also, depicted is the functionality allowing users and customers to browse and access entry level page displays.

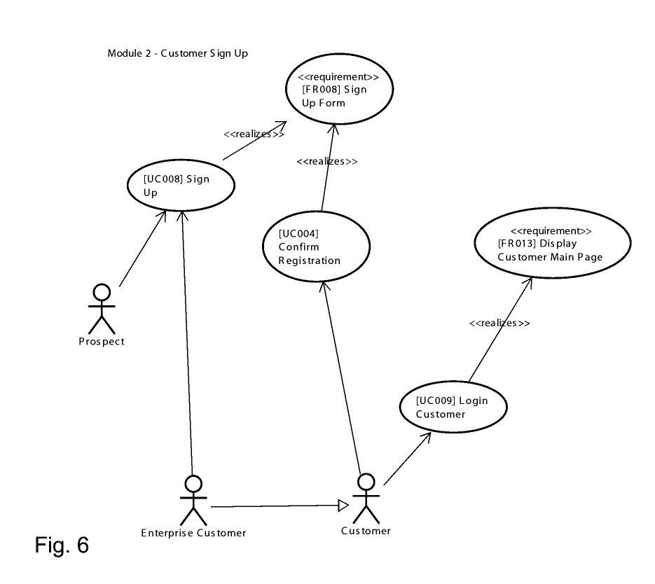

FIG. 6 depicts the functionality allowing prospects, enterprise and retail customers to register for use of the web site/service.

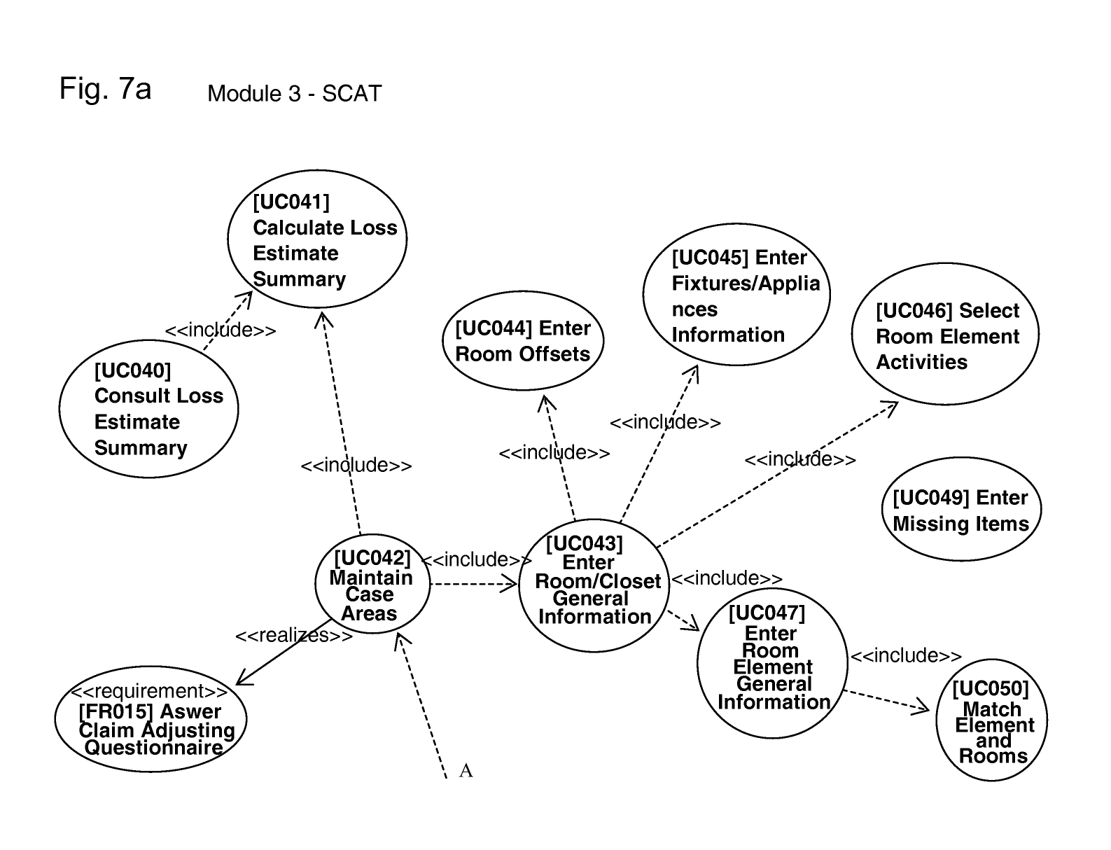

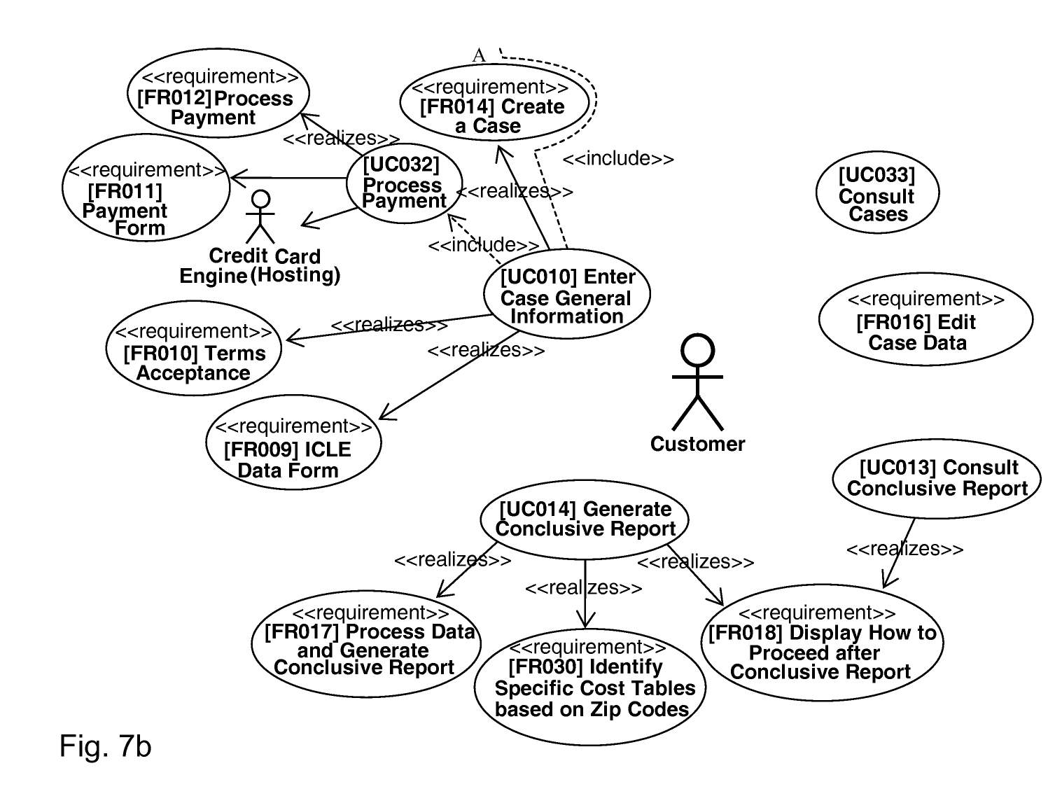

FIGS. 7a-7b depict the functionality for a customer to consult, enter data, generate a loss estimate including attending to matching issues, and generate a conclusive report. This feature allows a user to view but not change a claim once started but not yet finished.

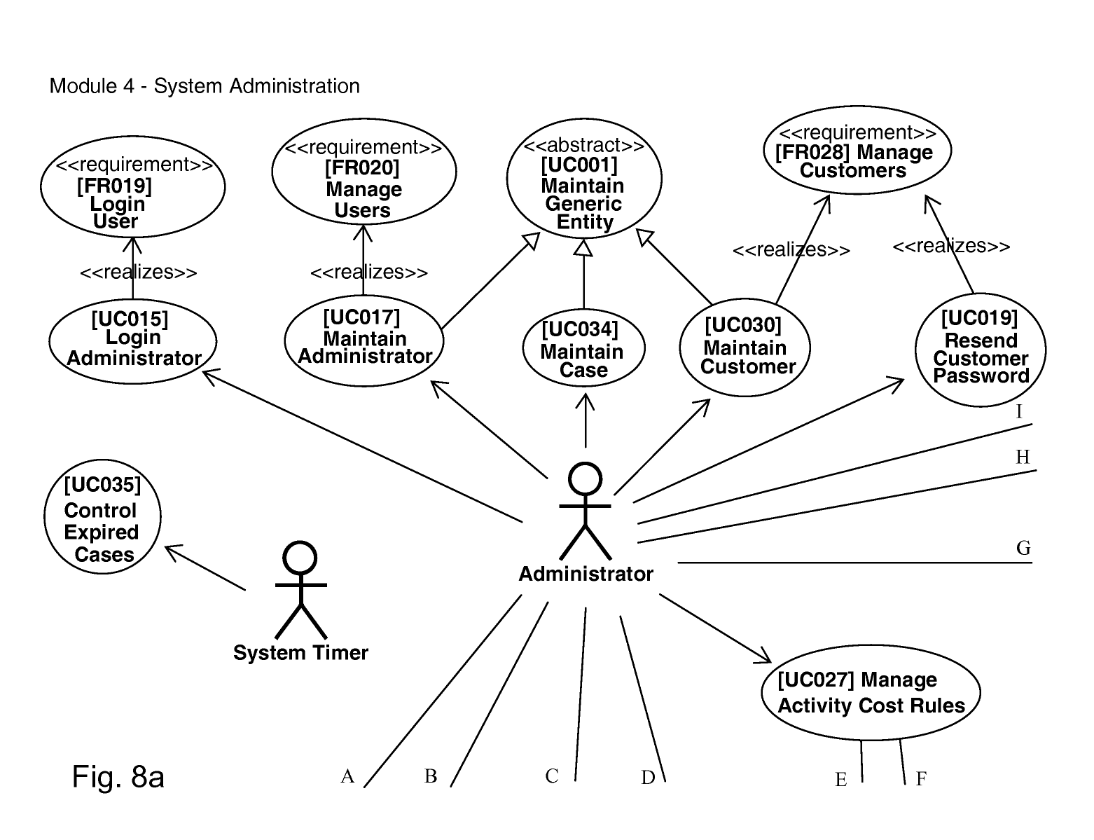

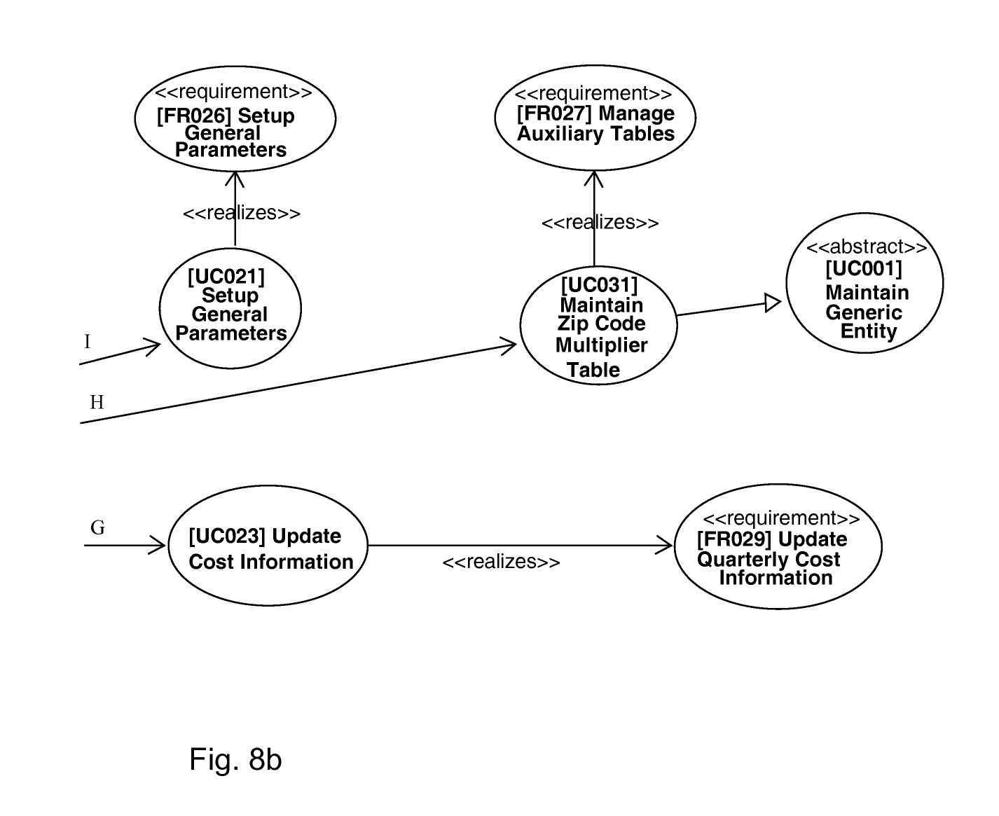

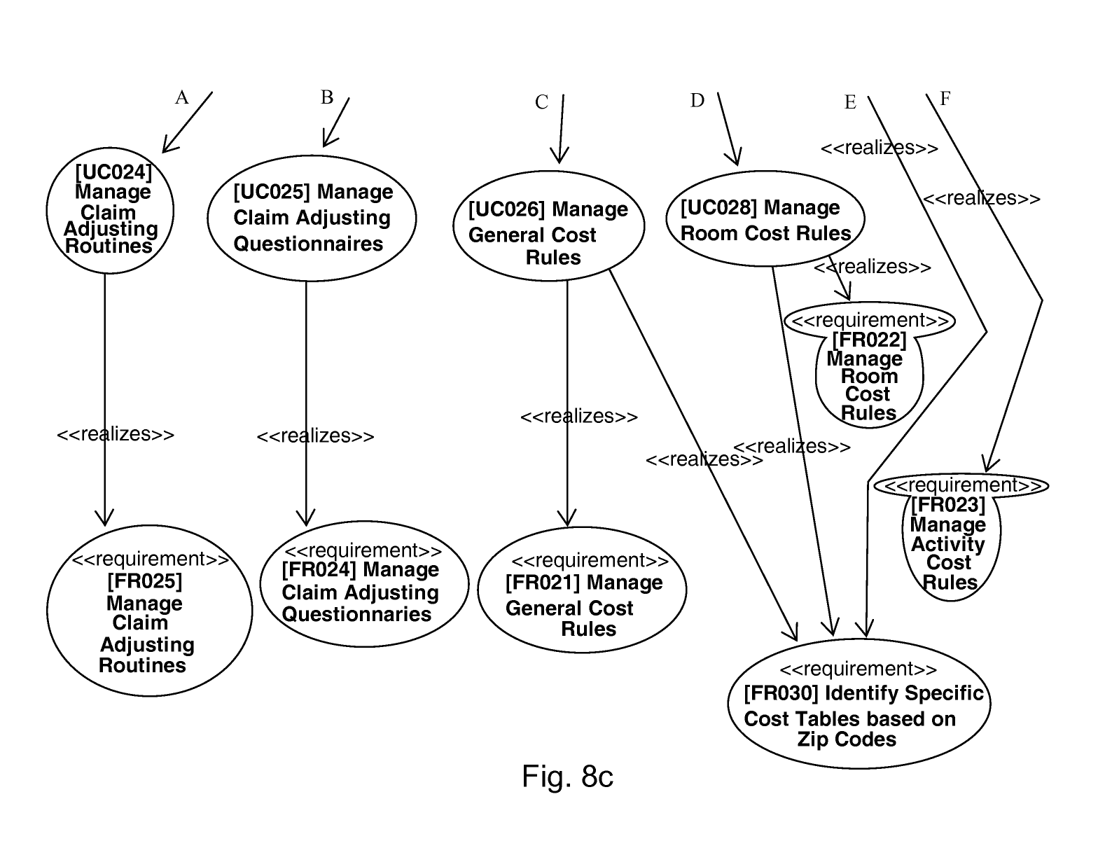

FIGS. 8a-8c depict administrator functionality to update information, such as cost data (use case 23, 49), geographic information (use case 31), costing rules (use case 26, 21), and other similar kinds of logical routines to assemble and calculate costs.

Attached hereto as Exhibit A is an eighteen page layout, with the pages being assembled six across in three separate rows to go from page 1 to page 18, of the database architecture accessed by the program to obtain information as necessary to perform. Layout as follows:

| | | | | | |
|---|---|---|---|---|---|
| Attachment A | Attachment B | Attachment C | Attachment D | Attachment E | Attachment F |
| Attachment G | Attachment H | Attachment I | Attachment J | Attachment K | Attachment L |
| Attachment M | Attachment N | Attachment O | Attachment P | Attachment Q | Attachment R |

In general, the architecture is set up in two halves, with the left half storing data relating to setting up the claim including the user entry of data, and the right half providing the data and storage relating to manipulating the data to generate the cost information needed to generate the proof of loss. While the inventors have adopted this particular database architecture, it would be understood by one of ordinary skill in the art that other architectures could be used and that successful operation of the program is not dependent on the particular architecture utilized.

Referring now to Exhibit B attached, a selection of various web page printouts are provided to illustrate the displays presently designed for presentation to a user as he accesses the web site, web portal, or otherwise uses the invention. The first page is a home page asking for the user to register or sign in. The second page is an information page describing the operation of the program and the various opportunities to proceed. Page 3 is an acknowledgement page that signals to a user that they have become qualified to start a claim. Page 4 illustrates the terms of use agreement and asks for acceptance before continuing. Page 5 is a questionnaire asking for insurance company information. Page 6 asks for the insured's (user's) information. Page 7 asks for credit card payment. Page 8 displays the claim number assigned to the user's claim for tracking purposes. Page 9 begins the inquiries asking for information relating to the insurance company loss estimate. Page 10 continues that inquiry, asking about which structures have experienced loss as reflected on the insurance company loss estimate. Page 11 continues asking about the insurance company loss estimate, with room details. Page 12 continues that inquiry, asking about detached structures. Page 13 continues by asking for confirmation of data entered from the insurance company loss estimate. Page 14 begins asking for data entry by the user to supplement the insurance company estimate, asking first for the user to select which of several rooms previously identified that the user wishes to enter data for. Page 15 asks the user to identify the ceiling shape for the room chosen. Page 16 asks the user to provide room dimensions and to identify elements contained within the room such as base molding, doors, windows, etc. Page 17 continues by asking for information relating to cabinetry that may have been contained in the room. It is noted that a running total of the loss estimate is displayed along the lower part of this and subsequent pages, with the program calculating this as the user enters data reflective of damage to the structure. Page 18 then asks for further detailed information for those room elements specified to be in the room previously. Such as the size of a window, etc. Page 19 summarizes the data entered so far for that room, and asks for the user to enter data from the insurance company loss estimate for repairs/renewal of that room. Page 20 asks for floor detail information and notably further asks the user if the floor has a finish match to the walls, carpet or floor in any other room. As the user is usually familiar with his house, he would know if a finish extends from one room to another, for example from a kitchen floor to a hall adjacent the kitchen. This entry triggers the matching issue, as described herein. Page 21 asks for information on the matching issue, asking the user to specify the room that has the selected matching finish. Page 22 asks for details relating to a wall, and asks if there is a wall having more than one type of finish. Page 23 asks for room details relating to a wall, such as the finish, matching finish issues, light switches, electrical outlets, etc. Page 24 asks for additional information relating to any room having a matching issue, in this example a common room which could be a hall. Page 25 asks for information relating to the ceiling in the room, and the presence of lights, outlets, etc. Page 26 asks detail information relating to any appliances included in the insurance company estimate. Page 27 asks the user to identify the appliances. Page 28 asks information relating to another room, such as a closet. Page 29 then is a room summary, summarizing data entered by the user and the calculation backing up the room total loss estimate displayed on this same page. Page 30 asks for detail about a garage door, to be added to the claim. By now, the user has gone through all the rooms in which there has been damage, rooms into which finishes extend to create matching issues, and this page 31 asks the user if he is ready to view the conclusive report or the proof of loss. The next twelve pages are printouts of an estimate that summarizes and supports the calculated loss estimate based upon the insurance company estimate as augmented by data entered by the user and as augmented by the program due to matching issues, etc. The last page in this Exhibit B is a “Sworn Statement in Proof of Loss” affidavit which is filled out and prepared for signature by the insured, printed out from the program, and which confirms the loss estimate. In sum, the invention thus produces not only a convenient affidavit for submission to the insurance company but also a detailed estimate calculating the cost to repair/renew the property and return it to its pre-loss condition.

Exhibit B is merely illustrative of the many various web page displays which are produced by the invention, and the invention should not be considered as being limited by particular graphics, arrangement, layout or other artistic representation used in these displays. Furthermore, for purposes of illustration, dummy data was used and entered for what would be a limited claim, and the full scope and capability of the invention has not thus been fully demonstrated. The invention should only be considered as limited by the legal scope of the claims appended hereto and their legal equivalents, For example, the present invention has been disclosed in terms of a residential property, but with minor programming and database changes could be adapted for use for commercial buildings, multi-family housing, etc. The present invention could also be made available in CD or DVD format, or otherwise distributed for use on a local computer/printer. Yet other changes would be apparent to those of skill in the art, using the present disclosure to guide them.

What is claimed is:

1. A computer implemented method for producing an estimate reflective of the cost to renew a damaged property, said method comprising:
providing a series of interactive displays containing inquiries for input by a user of a plurality of details concerning damage to various elements of a property,
receiving said plurality of details as entered by said user,
in response to said plurality of details, prompting said user to input further details concerning property elements related to the damaged elements,
calculating from said input details an estimate of the repair costs to renew said property, and
communicating said estimate to said user.

2. The method of claim 1 wherein calculating further comprises adding to said estimate a cost reflective of renewing both of the damaged elements and the related elements together.

3. The method of claim 2 wherein the step of providing a series of interactive displays includes inquiring for element input details regarding commonalities between said damaged elements and said related elements, said commonalities being likely to produce matching issues between said damaged and related elements.

4. The method of claim 3 wherein the step of calculating further comprises adding to said calculation a cost reflective of renewing the commonalities.

5. The method of claim 3 wherein said commonalities include element finishes, and wherein the step of calculating for costs reflective of commonalities includes calculating a cost reflective of renewing matching element finishes.

6. The method of claim 3 wherein said commonalities include construction materials, and wherein the step of calculating for costs reflective of commonalities includes calculating a cost reflective of renewing said construction materials.

7. The method of claim 3 wherein said commonalities include surface coverings, and wherein the step of calculating for costs reflective of commonalities includes calculating a cost reflective of renewing said surface coverings.

8. The method of claim 1 wherein the step of providing a series of interactive displays includes inquiring for element input details relating to a renewing step wherein a cost associated with each of said plurality of renewing steps is aggregated to reflect the cost for renewal of a property element.

9. The method of claim 8 wherein the step of calculating includes generating a cost assembly reflective of the cost to renew a property element based at least in part on the aggregated costs of its renewing steps.

10. The method of claim 9 wherein the step of calculating further comprises accessing a database storing a plurality of cost figures, said cost figures corresponding to a renewing step.

11. The method of claim 8 wherein said renewing steps correspond to steps required in a construction trade to achieve the renewing step in a workmanlike manner.

12. The method of claim 1 wherein the step of communicating the estimate to the user includes printing it.

13. The method of claim 1 further comprising the step of the user accessing said computer over a wide area network.

14. The method of claim 1 wherein the step of calculating includes the steps of adding a cost reflective of the cost for obtaining construction permits and sales tax on construction materials needed for performing the renewal.

15. An internet portal comprising a computer, said computer being configured to produce an estimate reflective of the cost to renew a damaged property including:
providing a series of interactive displays containing inquiries for input by a user over the internet of a plurality of details concerning damage to various elements of a property,
receiving said plurality of details as entered by said user,
in response to said plurality of details, prompting said user to input further details concerning property elements related to the damaged elements,
calculating from said input details for both of the damaged property elements and the related property elements an estimate of the repair costs to renew said property, and
communicating said estimate over the internet to said user.

16. The internet portal of claim 15 wherein the computer is further configured to add to said estimate a cost reflective of renewing both of the damaged elements and the related elements together.

17. The internet portal of claim 16 wherein the computer is further configured to provide a series of interactive displays including inquiring for element input details regarding commonalities between said damaged elements and said related elements, said commonalities being likely to produce matching issues between said damaged and related elements.

18. The internet portal of claim 17 wherein the computer is further configured to add to said calculation a cost reflective of renewing the commonalities.

19. The internet portal of claim 17 wherein said commonalities include element finishes, and wherein the computer is further configured to calculate costs reflective of commonalities including calculating a cost reflective of renewing matching element finishes.

20. The internet portal of claim 17 wherein said commonalities include construction materials, and wherein the computer is further configured to calculate costs reflective of commonalities includes calculating a cost reflective of renewing said construction materials.

21. The internet portal of claim 17 wherein said commonalities include surface coverings, and wherein the computer is further configured to calculate costs reflective of commonalities includes calculating a cost reflective of renewing said surface coverings.

22. The internet portal of claim 15 wherein the computer is further configured to inquire for element input details relating to a renewing step wherein a cost associated with each of said plurality of renewing steps is aggregated to reflect the cost for renewal of a property element.

23. The internet portal of claim 22 wherein the computer is further configured to calculate including generating a cost assembly reflective of the cost to renew a property element based at least in part on the aggregated costs of its renewing steps.

24. The internet portal of claim 23 wherein the computer is further configured to calculate including accessing a database storing a plurality of cost figures, said cost figures corresponding to a renewing step.

25. The internet portal of claim 22 wherein the computer is further configured to calculate said renewing steps corresponding to steps required in a construction trade to achieve the renewing step in a workmanlike manner.

26. The internet portal of claim 15 wherein the computer is further configured to communicate the estimate to the user in a format suitable for printing.

27. The internet portal of claim 15 wherein the computer is further configured to calculate including adding a cost reflective of the cost for obtaining construction permits and sales tax on construction materials needed for performing the renewal.
